(19) United States
(12) Patent Application Publication
(10) Pub. No.: US 2026/0210992 A1
(43) Pub. Date: Jul. 23, 2026

(54) RAPID ORIGINAL LIQUID DISTRIBUTION SYSTEM AND METHOD

(71) Applicant: TONGJI UNIVERSITY, Shanghai (CN)

(72) Inventors: Linhua JIANG, Shanghai (CN); Ning DUAN, Shanghai (CN)

(21) Appl. No.: 19/451,635

(22) Filed: Jan. 16, 2026

Related U.S. Application Data
(63) Continuation of application No. PCT/CN2024/111365, filed on Aug. 12, 2024.

(30) Foreign Application Priority Data
Jul. 25, 2024 (CN) 202411001986.4

(51) Int. Cl. G01N 35/10

(52) U.S. Cl. CPC G01N 35/1016; G01N 35/1095

(57) ABSTRACT

A rapid original liquid distribution system and method, and relate to the field of process industry technologies are provided. The original liquid distribution includes a programmable logic controller (PLC)-based conveying and distribution control module, a continuous sample collection module, a liquid distribution module, a real-time original liquid monitoring module, a liquid confluence and reuse module, a reaction unit group, and an overflow channel. Spectral signals of samples of different concentrations under static conditions are detected by the real-time original liquid monitoring module. The spectral signals under the static conditions can be compared at different liquid inlet flow velocities, to rapidly select a liquid inlet flow velocity that corresponds to a spectrum with a highest degree of overlap and a lowest noise, and determine an optimal flow rate and flow velocity for the liquid in the corresponding module.

### CROSS REFERENCE TO RELATED APPLICATION

This patent application is a continuation of International Patent Application No. PCT/CN2024/111365, filed on Aug. 12, 2024, which claims the benefit and priority of Chinese Patent Application No. 202411001986.4, filed with the China National Intellectual Property Administration on Jul. 25, 2024, the disclosure of which is incorporated by reference herein in its entirety as part of the present application.

### TECHNICAL FIELD

The present disclosure relates to the field of process industry technologies, and specifically, relates to a rapid original liquid distribution system and method.

### BACKGROUND

Process industry, also known as process manufacturing, refers to a production process performed through physical changes, chemical changes, or a combination of both. Raw materials and products of the process industry are mostly homogeneous materials (solid, liquid, or gas), rather than objects assembled from individual parts. Industries such as chemical, oil refining, metallurgy, light industry, building materials, and pharmaceuticals all fall within the scope of process industry. The process industry primarily adds value to raw materials through mixing, forming, or chemical reactions, for example, production of pharmaceuticals, chemicals, and food beverages. Numerous physical and chemical changes are inherent to process industry manufacturing. With digital transformation of process industry manufacturing, higher precision requirements for liquid distribution are posed during processing of the homogeneous materials.

However, multivariate reaction processes in the process industry commonly feature a fast reaction rate, a numerous reactant type, and coexistence of gas, solid, and liquid. In addition, characteristics such as concentration, temperature, salinity, and viscosity of liquids can vary significantly across different reaction units.

An existing liquid sample collection system can perform continuous sampling, but can convey liquids only under predetermined distribution flow control, and cannot adjust a distribution ratio between distribution modules based on actual flow rate requirements of the distribution modules in real time, making it difficult to meet long-distance liquid supply requirements. In addition, a chemical reaction speed involved in the process industry is high, causing physicochemical properties of sampled materials to change easily. If timeliness of liquid distribution cannot be guaranteed, materials with changed properties have adverse impact on detections results, compromising accuracy of the detections results. Therefore, a rapid original liquid distribution system and method are provided, to adjust the distribution ratios between the distribution modules in real time, and improve accuracy of the detection results.

### SUMMARY

An objective of the present disclosure is to provide a rapid original liquid distribution system and method, to resolve the problems in the background.

To achieve the above objective, the present disclosure provides the following technical solution:

According to an aspect, a rapid original liquid distribution system is provided, including a programmable logic controller (PLC)-based conveying and distribution control module, a continuous sample collection module, a liquid distribution module, a real-time original liquid monitoring module, a liquid confluence and reuse module, a reaction unit group, and an overflow channel;
The PLC-based conveying and distribution control module, the continuous sample collection module, the liquid distribution module, the real-time original liquid monitoring module, and the liquid confluence and reuse module each include at least one signal transceiver;
The PLC-based conveying and distribution control module is configured to: perform closed-loop control on liquid distribution, and dynamically adjust liquid distribution time, a flow rate, and a flow velocity. An output end of the PLC-based conveying and distribution control module is separately connected to the continuous sample collection module, the liquid distribution module, the real-time original liquid monitoring module, and the liquid confluence and reuse module electrically. The PLC-based conveying and distribution control module is configured to separately send a control instruction to the continuous sample collection module, the liquid distribution module, the real-time original liquid monitoring module, and the liquid confluence and reuse module;
The original liquid may be one or a combination including multiple of domestic water, wastewater, industrial water, or an industrial reaction liquid;
An upstream pipeline of the continuous sample collection module is connected to the reaction unit group, and a downstream pipeline of the reaction unit group is connected to the liquid confluence and reuse module. The continuous sample collection module is configured to dynamically adjust a total quantity of collected samples by receiving a conveying and distribution control instruction from the PLC-based conveying and distribution control module, to meet total time duration and total liquid consumption for liquid distribution of the original liquid distribution method;
An upstream of the liquid distribution module is connected to the continuous sample collection module via a pipeline, and a downstream of the liquid distribution module is connected to the real-time original liquid monitoring module via a pipeline. The liquid distribution module is configured to dynamically adjust a liquid inflow rate of the real-time original liquid monitoring module by receiving the conveying and distribution control instruction from the PLC-based conveying and distribution control module;
The real-time original liquid monitoring module is configured to: monitor and analyze a spectral signal-to-noise ratio of liquid samples in the reaction unit group, and send a signal-to-noise ratio detection result to the PLC-based conveying and distribution control module in a positive feedback form or a negative feedback form, to dynamically adjust the liquid inflow rate and a flow velocity of the real-time original liquid monitoring module;
The liquid confluence and reuse module is configured to: monitor a reflux liquid, and distribute the reflux liquid to an adaptive reaction unit in the reaction unit group, to distribute and recycle the reflux liquid.

As a further solution of the present disclosure, the reaction unit group includes multiple sub-reaction units that are connected in parallel, and conveying pipelines respectively connected to adjacent sub-reaction units of the multiple sub-reaction units that are connected in parallel are independent and parallel to each other. The multiple sub-reaction units that are connected in parallel are separately connected between the continuous sample collection module and the liquid confluence and reuse module. Liquid samples loaded in different sub-reaction units are not exactly the same in concentrations, temperatures, salinities, and viscosities.

As a further solution of the present disclosure, liquid samples loaded in different sub-reaction units are not exactly the same in concentrations, temperatures, salinities, and viscosities.

As a further solution of the present disclosure, the reaction unit group includes a first reaction unit, a second reaction unit, and a third reaction unit, and the first reaction unit, the second reaction unit, and the third reaction unit are all liquid reaction vessels.

As a further solution of the present disclosure, the continuous sample collection module is configured to: continuously collect the liquid samples contained in the first reaction unit, the second reaction unit, and the third reaction unit and convey the collected liquid samples to the liquid distribution module. The continuous sample collection module is configured to dynamically adjust flow rates and flow velocities of the liquid samples collected based on a control instruction sent by the PLC-based conveying and distribution control module.

As a further solution of the present disclosure, the original liquid distribution method further includes an overflow channel. The overflow channel is connected between the liquid distribution module and the liquid confluence and reuse module, and the overflow channel is configured to converge an excess liquid distributed by the liquid distribution module to the real-time original liquid monitoring module to the liquid confluence and reuse module; and an overflow port is formed at a joint between the overflow channel and the liquid distribution module, and the excess liquid enters the overflow channel through the overflow port, and is conveyed to the liquid confluence and reuse module through the corresponding overflow channel, so as to adjust a flow rate in the real-time original liquid monitoring module.

As a further solution of the present disclosure, the liquid confluence and reuse module includes a signal transceiver and a liquid pump. The signal transceiver is configured to receive a quality-based control instruction from the PLC-based conveying and distribution control module, and the liquid pump, as a quality-controlled pump, is configured to convey an excess liquid to an adaptive sub-reaction unit. The liquid is actively pumped out by the quality-controlled pump, and the converged liquid is passively received by the sub-reaction units.

According to another aspect, a rapid original liquid distribution method is further provided, applied to the original liquid distribution method, including the following steps:
S1, dynamically adjusting a flow rate Q and a flow velocity V of liquids sucked into different reaction units based on a conveying distance L and a pipeline cross-sectional area S, where
distribution time t=conveying distance L÷flow velocity V; and
flow velocity V=flow rate Q÷pipeline cross-sectional area S;
S2, calculating the flow velocity V based on the distribution time t and the conveying distance L according to a formula:
   t (min)=L(m)÷V (m/min)≤1 min→V (m/min);
S3, calculating the flow rate Q based on the flow velocity V and the pipeline cross-sectional area S according to a formula:
V (m/min)=Q(ml/min)÷S(mm²)→Q(ml/min), and determining a flow rate Q(ml/min) and a flow velocity V (m/min) for dynamic and continuous collection and distribution of the liquids in different reaction units, where
the conveying distance can be measured onsite, the flow rate can be directly adjusted and controlled on site, and the flow velocity is a calculated result;
S4, monitoring spectral signals of the liquids in different reaction units under static conditions, and obtaining absorption intensities and noise fluctuations corresponding to concentrations of the liquids in different reaction units under static conditions;
During monitoring, a principle that a similarity is greater than or equal to 99% under both dynamic and static noise conditions is adopted to separately monitor spectral signals of with different concentrations under the static and dynamic conditions. The spectral signal is an absorbance intensity Abs value signal at each wavelength within a wavelength range of 180 nm to 900 nm. This spectral signal is monitored by the real-time original liquid monitoring module;
Based on preset standard values for a flow rate and a flow velocity in the PLC-based conveying and distribution control module, an optimal flow rate and an optimal flow velocity for liquid inflow are automatically matched by the PLC-based conveying and distribution control module. The liquid flow rate is driven by negative pressure suction of a peristaltic pump, and a magnitude of the liquid flow rate can be adjusted by changing a rotational speed of the peristaltic pump;
A calculation formula for the flow velocity is: flow velocity=flow rate/pipe diameter. Under a premise of a constant pipe diameter, a magnitude of the flow velocity is determined by a magnitude of the flow rate, and disturbance of a sample within a flow cell of the real-time original liquid monitoring module is greatly affected by the magnitude of the flow velocity. If the flow velocity is too low, the sample is prone to forming a flow field dead zone within the cell, which affects detection sensitivity. However, when the flow velocity is too high, a sample noise has a great impact on the spectral signal. Therefore, it is necessary to first detect spectral signals of samples of different concentrations under the static conditions. Then, under different inlet flow velocity conditions, the spectral signals are compared and benchmarked against corresponding static signals of the spectral signals. The inlet flow velocity corresponding to a spectrum with a highest degree of overlap and a lowest noise is selected to determine the corresponding optimal flow rate;
S5, dynamically monitoring a spectral signal of a target liquid under different liquid inlet conditions including different flow rates and different flow velocities, and obtaining light absorption intensities and noise fluctuations corresponding to target liquids of different concentrations under dynamic conditions.

As a further solution of the present disclosure, in the step S2, total time duration t of a process from sample collection, to distribution, to real-time monitoring, to confluence and reuse is less than or equal to 1 min.

As a further solution of the present disclosure, under the static conditions, the concentrations of the liquids in the different reaction units are C₁, C₂, . . . , Cₙ;
light absorption intensities corresponding to the concentrations of the liquids in the different reaction units are Ia₁, Ia₂, . . . , Iaₙ; and
noise fluctuations corresponding to the concentrations of the liquids in the different reaction units are ΔIa₁, ΔIa₂, . . . , ΔIaₙ.

As a further solution of the present disclosure, under the dynamic conditions, the concentrations of the liquids in the different reaction units are C₁′, C₂′, . . . , Cₙ′;
light absorption intensities corresponding to the liquids in the different reaction units are Ia₁′, Ia₂′, . . . , Iaₙ′; and
noise fluctuations corresponding to the liquids in the different reaction units are ΔIa₁′, ΔIa₂′, . . . , ΔIaₙ′.

Compared with the conventional technology, the present disclosure has the following beneficial effects:

Spectral signals of samples of different concentrations under the static conditions are detected by the real-time original liquid monitoring module. The spectral signals under the static conditions can be compared at different liquid inlet flow velocities, to rapidly select a liquid inlet flow velocity that corresponds to a spectrum with a highest degree of overlap and a lowest noise, and determine an optimal flow rate and an optimal flow velocity for the liquid in the corresponding module by the PLC-based conveying and distribution control module 1. In this way, real-time dynamic adjustment for a flow rate and a flow velocity of a liquid sample in the original liquid distribution method is achieved, long-distance liquid supply requirements can be met, timeliness of liquid distribution can be ensured, adverse impact of materials with changed properties on a detection result is avoided, and accuracy of the liquid material detection result is enhanced.

### BRIEF DESCRIPTION OF THE DRAWINGS

FIG. 1 is a schematic diagram of a distribution system according to the present disclosure.

### REFERENCE NUMERALS

1, PLC-based conveying and distribution control module 2, continuous sample collection module; 3, liquid distribution module; 4, real-time original liquid monitoring module; 5, liquid confluence and reuse module; 6, reaction unit group; 61, first reaction unit; 62, second reaction unit; 63, third reaction unit; and 7, overflow channel.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All the other embodiments derived by those of ordinary skill in the art based on the embodiments of the present disclosure without creative efforts shall fall within the protection scope of the present disclosure.

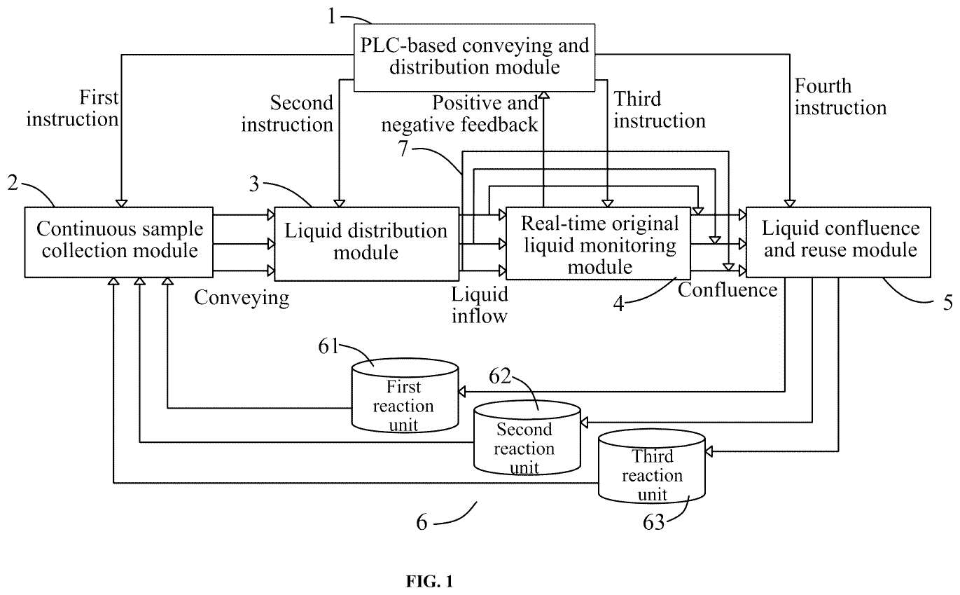

As shown in FIG. 1, a rapid original liquid distribution system provided in the present disclosure includes a programmable logic controller (PLC)-based conveying and distribution control module 1, a continuous sample collection module 2, a liquid distribution module 3, a real-time original liquid monitoring module 4, a liquid confluence and reuse module 5, a reaction unit group 6, and an overflow channel 7. The PLC-based conveying and distribution control module 1, the continuous sample collection module 2, the liquid distribution module 3, the real-time original liquid monitoring module 4, and the liquid confluence and reuse module 5 each include at least one signal transceiver.

The original liquid distribution method includes the overflow channel 7. The overflow channel 7 is connected between the liquid distribution module 3 and the liquid confluence and reuse module 5, and the overflow channel 7 is configured to convey an excess liquid distributed by the liquid distribution module 3 to the real-time original liquid monitoring module 4 to the liquid confluence and reuse module 5. An overflow port is formed at a joint between the overflow channel 7 and the liquid distribution module 3, and the excess liquid enters the overflow channel 7 through the overflow port, and is conveyed to the liquid confluence and reuse module 5 through the corresponding overflow channel 7, so as to adjust a flow rate in the real-time original liquid monitoring module 4. The original liquid may be one or a combination including multiple of domestic water, wastewater, industrial water, or an industrial reaction liquid.

### Embodiment 1

The PLC-based conveying and distribution control module 1 is configured to: perform closed-loop control on liquid distribution, and dynamically adjust liquid distribution time, a flow rate, and a flow velocity. An output end of the PLC-based conveying and distribution control module 1 is separately connected to the continuous sample collection module 2, the liquid distribution module 3, the real-time original liquid monitoring module 4, and the liquid confluence and reuse module 5 electrically. The PLC-based conveying and distribution control module 1 is configured to send a control signal to the continuous sample collection module 2 as a first instruction. The PLC-based conveying and distribution control module 1 is configured to send a control signal to the liquid distribution module 3 as a second instruction. The PLC-based conveying and distribution control module 1 is configured to send a control signal to the real-time original liquid monitoring module 4 as a third instruction. The PLC-based conveying and distribution control module 1 is configured to send a control signal to the liquid confluence and reuse module 5 as a fourth instruction.

An upstream pipeline of the continuous sample collection module 2 is connected to the reaction unit group 6, and a downstream pipeline of the reaction unit group 6 is connected to the liquid confluence and reuse module 5. The continuous sample collection module 2 is configured to dynamically adjust a total quantity of collected samples by receiving a conveying and distribution control instruction from the PLC-based conveying and distribution control module 1, to meet total time duration and total liquid consumption for liquid distribution of the original liquid distribution method.

An upstream of the liquid distribution module 3 is connected to the continuous sample collection module via a pipeline 2, and a downstream of the liquid distribution module 3 is connected to the real-time original liquid monitoring module 4 via a pipeline. The liquid distribution module 3 is configured to dynamically adjust a liquid inflow rate of the real-time original liquid monitoring module 4 by receiving the conveying and distribution control instruction from the PLC-based conveying and distribution control module 1.

The real-time original liquid monitoring module 4 is configured to: monitor and analyze a spectral signal-to-noise ratio of a liquid sample in the reaction unit group 6, and send a signal-to-noise ratio detection result to the PLC-based conveying and distribution control module 1 in a positive feedback form or a negative feedback form, to dynamically adjust the liquid inflow rate and a flow velocity of the real-time original liquid monitoring module 4.

The liquid confluence and reuse module 5 is configured to: monitor a reflux liquid, and distribute the reflux liquid to an adaptive reaction unit in the reaction unit group 6, to distribute and recycle the reflux liquid.

Optionally, the reaction unit group 6 includes multiple sub-reaction units that are connected in parallel, and conveying pipelines respectively connected to adjacent sub-reaction units of the multiple sub-reaction units that are connected in parallel are independent and parallel to each other. The multiple sub-reaction units that are connected in parallel are separately connected between the continuous sample collection module 2 and the liquid confluence and reuse module 5. Liquid samples loaded in different sub-reaction units are not exactly the same in concentrations, temperatures, salinities, and viscosities.

Optionally, the continuous sample collection module 2 is configured to: continuously collect the liquid samples contained in the multiple sub-reaction units that are connected in parallel and convey the collected liquid samples to the liquid distribution module 3. The continuous sample collection module 2 is configured to dynamically adjust flow rates and flow velocities of the liquid samples collected based on a control instruction sent by the PLC-based conveying and distribution control module 1.

Optionally, the liquid confluence and reuse module 5 includes a signal transceiver and a liquid pump. The signal transceiver is configured to receive a quality-based control instruction from the PLC-based conveying and distribution control module 1, and the liquid pump, as a quality-controlled pump, is configured to convey an excess liquid to an adaptive sub-reaction unit. The liquid is actively pumped out by the quality-controlled pump, and the converged liquid is passively received by the sub-reaction units.

### Embodiment 2

A difference between Embodiment 2 and the foregoing embodiment lies in that:

Liquid samples loaded in different sub-reaction units are not exactly the same in concentrations, temperatures, salinities, and viscosities.

The reaction unit group 6 includes a first reaction unit 61, a second reaction unit 62, and a third reaction unit 63. The first reaction unit 61, the second reaction unit 62, and the third reaction unit 63 are all liquid reaction vessels. The first reaction unit 61, the second reaction unit 62, and the third reaction unit 63 are separately connected between the continuous sample collection module 2 and the liquid confluence and reuse module 5 through independent pipelines.

Optionally, the continuous sample collection module 2 is configured to: continuously collect the liquid samples contained in the first reaction unit 61, the second reaction unit 62, and the third reaction unit 63 and convey the collected liquid samples to the liquid distribution module 3. The continuous sample collection module 2 is configured to dynamically adjust flow rates and flow velocities of the liquid samples collected based on a control instruction sent by the PLC-based conveying and distribution control module 1.

The liquid samples are distributed according to the following steps.

First, a flow rate Q and a flow velocity V of liquids sucked into different reaction units are dynamically adjusted based on a conveying distance L and a pipeline cross-sectional area S, where
distribution time t=conveying distance L÷flow velocity V; and
flow velocity V=flow rate Q÷pipeline cross-sectional area S;
Then, the flow velocity V is calculated based on the distribution time t and the conveying distance L according to a formula:
t (min)=L(m)÷V (m/min)≤1 min→V (m/min);
The flow rate Q is calculated based on the flow velocity V and the pipeline cross-sectional area S according to a formula:
V (m/min)=Q(ml/min)÷S(mm²)→Q(ml/min), and a flow rate Q(ml/min) and a flow velocity V (m/min) for dynamic and continuous collection and distribution of the liquids in the different reaction units are determined;
The conveying distance can be measured onsite, the flow rate can be directly adjusted and controlled on site, and the flow velocity is a calculated result;
Then, spectral signals of the liquids in the different reaction units under static conditions are monitored, and absorption intensities and noise fluctuations corresponding to concentrations of the liquids in the different reaction units under static conditions are obtained;
Finally, a spectral signal of a target liquid under different liquid inlet conditions including different flow rates and different flow velocities is dynamically monitored, and light absorption intensities and noise fluctuations corresponding to target liquids of different concentrations under the dynamic conditions are obtained.

Preferably, total time duration t of a process from sample collection, to distribution, to real-time monitoring, to confluence and reuse is less than or equal to 1 min.

Preferably, under the static conditions, the concentrations of the liquids in the different reaction units are C₁, C₂, . . . , Cₙ.

Light absorption intensities corresponding to the concentrations of the liquids in the different reaction units are Ia₁, Ia₂, . . . , Iaₙ.

Noise fluctuations corresponding to the concentrations of the liquids in the different reaction units are ΔIa₁, ΔIa₂, . . . , ΔIaₙ.

Preferably, under the dynamic conditions, the concentrations of the liquids in the different reaction units are C₁′, C₂′, . . . , Cₙ′.

Light absorption intensities corresponding to the liquids in the different reaction units are Ia₁′, Ia₂′, . . . , Iaₙ′.

Noise fluctuations corresponding to the liquids in the different reaction units are ΔIa₁′ ΔIa₂′, . . . , ΔIaₙ′.

During monitoring, a principle that a similarity is greater than or equal to 99% under both dynamic and static noise conditions is adopted to separately monitor spectral signals of with different concentrations under the static and dynamic conditions. The spectral signal is an absorbance intensity Abs value signal at each wavelength within a wavelength range of 180 nm to 900 nm. This spectral signal is monitored by the real-time original liquid monitoring module.

Based on preset standard values for a flow rate and a flow velocity in the PLC-based conveying and distribution control module 1, an optimal flow rate and an optimal flow velocity for liquid inflow are automatically matched by the PLC-based conveying and distribution control module 1. The liquid flow rate is driven by negative pressure suction of a peristaltic pump, and a magnitude of the liquid flow rate can be adjusted by changing a rotational speed of the peristaltic pump.

A calculation formula for the flow velocity is: flow velocity=flow rate/pipeline cross-sectional area. Under a premise of a constant pipeline cross-sectional area, a magnitude of the flow velocity is determined by a magnitude of the flow rate, and disturbance of a sample within a flow cell of the real-time original liquid monitoring module 4 is greatly affected by the magnitude of the flow velocity. If the flow velocity is too low, the sample is prone to forming a flow field dead zone within the cell, which affects detection sensitivity. However, when the flow velocity is too high, a sample noise has a great impact on the spectral signal. Therefore, it is necessary to first detect spectral signals of samples of different concentrations under the static conditions. Then, under different inlet flow velocity conditions, dynamic spectral signals are compared and benchmarked against static spectral signals. The inlet flow velocity corresponding to a spectrum with a highest degree of overlap and a lowest noise is selected to determine the corresponding optimal flow rate.

Spectral signals of samples of different concentrations under the static conditions are detected by the real-time original liquid monitoring module 4. The spectral signals under the static conditions can be compared at different liquid inlet flow velocities, to rapidly select a liquid inlet flow velocity that corresponds to a spectrum with a highest degree of overlap and a lowest noise, and determine an optimal flow rate and an optimal flow velocity for the liquid in the corresponding module by the PLC-based conveying and distribution control module 1. In this way, real-time dynamic adjustment for a flow rate and a flow velocity of a liquid sample in the original liquid distribution method is achieved, long-distance liquid supply requirements can be met, timeliness of liquid distribution can be ensured, adverse impact of materials with changed properties on a detection result is avoided, and accuracy of the liquid material detection result is enhanced.

It should be noted that relational terms herein such as first and second are merely used to distinguish one entity or operation from another entity or operation without necessarily requiring or implying any actual such relationship or order between such entities or operations. In addition, terms “include”, “comprise”, or their any other variations are intended to cover a non-exclusive inclusion, such that a process, a method, an article, or a device that includes a series of elements not only includes those elements, but also includes other elements that are not explicitly listed, or also includes inherent elements of the process, the method, the article, or the device.

Although the examples of the present disclosure have been illustrated and described, it should be understood that those of ordinary skill in the art may make various changes, modifications, replacements and variations to the above examples without departing from the principle and spirit of the present disclosure, and the scope of the present disclosure is limited by the appended claims and their legal equivalents.

What is claimed is:

1. A rapid original liquid distribution system, comprising:
a programmable logic controller (PLC)-based conveying and distribution control module, wherein the PLC-based conveying and distribution control module is configured to: perform closed-loop control on liquid distribution, and dynamically adjust liquid distribution time, a flow rate, and a flow velocity;
a continuous sample collection module, wherein an upstream pipeline of the continuous sample collection module is connected to a reaction unit group, and the continuous sample collection module is configured to dynamically adjust a total quantity of collected samples by receiving a conveying and distribution control instruction from the PLC-based conveying and distribution control module; the reaction unit group comprises a first reaction unit, a second reaction unit, and a third reaction unit, and the first reaction unit, the second reaction unit, and the third reaction unit are all liquid reaction vessels; and the continuous sample collection module is configured to: continuously collect the liquid samples contained in the first reaction unit, the second reaction unit, and the third reaction unit and convey the collected liquid samples to the liquid distribution module;
a liquid distribution module, wherein an upstream of the liquid distribution module is connected to the continuous sample collection module via a pipeline, a downstream of the liquid distribution module is connected to a real-time original liquid monitoring module via a pipeline; and the liquid distribution module is configured to dynamically adjust a liquid inflow rate of the real-time original liquid monitoring module by receiving the conveying and distribution control instruction from the PLC-based conveying and distribution control module; and
the real-time original liquid monitoring module is configured to: monitor and analyze a spectral signal-to-noise ratio of liquid samples in the reaction unit group, and is specifically configured to: obtain spectral signals of liquids of different concentrations under static conditions as a reference standard, adjust the liquid inflow rate under dynamic conditions to make a dynamic spectral signal achieve optimal overlap with a static reference while minimizing a noise; and feed back a signal-to-noise ratio detection result to the PLC-based conveying and distribution control module; wherein the reaction unit group comprises multiple sub-reaction units that are connected in parallel, and conveying pipelines respectively connected to adjacent ones of the multiple sub-reaction units are independent and parallel to each other; and
a liquid confluence and reuse module, wherein the liquid confluence and reuse module is configured to: monitor a reflux liquid, and distribute the reflux liquid to an adaptive reaction unit in the reaction unit group; and the liquid confluence and reuse module comprises a signal transceiver and a liquid pump, the signal transceiver is configured to receive a quality-based control instruction from the PLC-based conveying and distribution control module, and the liquid pump, as a quality-controlled pump, is configured to convey an excess liquid to an adaptive sub-reaction unit.

2. The rapid original liquid distribution system according to claim 1, wherein the system further comprises:
an overflow channel, wherein the overflow channel is connected between the liquid distribution module and the liquid confluence and reuse module, and the overflow channel is configured to converge an excess liquid distributed by the liquid distribution module to the real-time original liquid monitoring module to the liquid confluence and reuse module; and an overflow port is formed at a joint between the overflow channel and the liquid distribution module.

3. A rapid original liquid distribution method, applied to the rapid original liquid distribution system according to claim 1, comprising following steps:
S1, dynamically adjusting a flow rate Q and a flow velocity V of liquids sucked into different reaction units based on a conveying distance L and a pipeline cross-sectional area S;
S2, calculating the flow velocity V based on distribution time t and the conveying distance L according to a formula: t (min)=L(m)÷V (m/min);
S3, calculating the flow rate Q based on the flow velocity V and the pipeline cross-sectional area S according to a formula: V (m/min)=Q(ml/min)÷S(mm²);
S4, monitoring spectral signals of the liquids in the different reaction units under the static conditions, and obtaining absorption intensities and noise fluctuations corresponding to concentrations of the liquids in the different reaction units under the static conditions; and
S5, dynamically monitoring a spectral signal of a target liquid under different liquid inlet conditions comprising different flow rates and different flow velocities, and obtaining light absorption intensities and noise fluctuations corresponding to target liquids of different concentrations under dynamic conditions.

4. The rapid original liquid distribution method according to claim 3, wherein in the step S2, total time duration t of a process from sample collection, to distribution, to real-time monitoring, to confluence and reuse is less than or equal to 1 min.

5. The rapid original liquid distribution method according to claim 4, wherein under the static conditions, the concentrations of the liquids in the different reaction units are C₁, C₂, . . . , Cₙ;
light absorption intensities corresponding to the concentrations of the liquids in the different reaction units are Ia₁, Ia₂, . . . , Iaₙ; and
noise fluctuations corresponding to the concentrations of the liquids in the different reaction units are ΔIa₁, ΔIa₂, . . . , ΔIaₙ.

6. The rapid original liquid distribution method according to claim 5, wherein
under the dynamic conditions, the concentrations of the liquids in the different reaction units are C₁′, C₂′, . . . , Cₙ′;
light absorption intensities corresponding to the liquids in the different reaction units are Ia₁′, Ia₂′, . . . , Iaₙ′; and
noise fluctuations corresponding to the liquids in the different reaction units are ΔIa₁′, ΔIa₂′, . . . , ΔIaₙ′.

7. The rapid original liquid distribution method according to claim 3, wherein the system further comprises:
an overflow channel, wherein the overflow channel is connected between the liquid distribution module and the liquid confluence and reuse module, and the overflow channel is configured to converge an excess liquid distributed by the liquid distribution module to the real-time original liquid monitoring module to the liquid confluence and reuse module; and an overflow port is formed at a joint between the overflow channel and the liquid distribution module.
